(19) United States
(12) Patent Application Publication
(10) Pub. No.: US 2007/0136491 A1
(43) Pub. Date: Jun. 14, 2007

(54) Computing system, method and computer readable medium for group interactive multicast using UPnP AV architecture

(76) Inventors: Min Di, Ban-Chia (TW); Bing-Huan Shie, Taipei (TW); Jason Wei, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/366,056

(22) Filed: Mar. 2, 2006

(30) Foreign Application Priority Data
Dec. 13, 2005 (TW) 094144108

(51) Int. Cl. G06F 15/173

(52) U.S. Cl. 709/238

(57) ABSTRACT

A computing system, method and computer readable media for group interactive multicast using UPnP AV architecture on a network are disclosed. The system comprises a plurality of devices and control points coupled to the network. The devices include a plurality of renders and a server, in which those renders form a group. The server comprises a data recording medium for saving a group list of the group. The control points comprise a server control point and a plurality of render control points. The control points are utilized to control the server and the renders and to register events. As one of the render control points correspondingly sends a command to one of the renders of the group, the render, which receives the command, will feedback a UPnP event to the server. The server will transfer the command to those renders, which do not receive the command before, so as to make those renders of the group to execute the command simultaneously.

### CROSS-REFERENCES TO RELATED APPLICATIONS

This application claims priority to Taiwan Patent Application No. 094144108 filed on Dec. 13, 2005.

### BACKGROUND OF THE INVENTION

1. Field of the Invention

The invention relates to a computing system, a method and a computer readable medium thereof for group interactive multicast; specifically to a computing system, a method and a computer readable medium thereof for group interactive multicast utilizing a UPnP AV architecture.

2. Descriptions of the Related Art

With the rapid development of the technology of communication online, the demand of information transmission is increasing day by day. Especially, the application of video and audio information is more popular. For example, it can be applied in digital families, conferences, meetings, exhibits and schools, etc. Universal Plug and Play (UPnP) architecture, which is established by UPnP forum, is the architecture of point to point online connection for personal computers, intellectual instruments and wireless equipments. Except for data transmission and control among network devices of families, offices and so forth, this distributed, open network structure could be also connected by TCP/IP and internet.

UPnP architecture could use two things to describe. One is the device and the other is the control point (CP). The architecture of UPnP equipment defines a serious of operation standers which support the communication among the network equipments. Once a UPnP device connects to a network, it send news via the network to show it could provide services for clients. The other equipment of the network is the control point which acts as a controller to receive news about the availability of devices or locates UPnP devices by sending requests via the network. After the control point finds out one device, by way of receiving the news or requesting by itself, it could obtain the substantial description of that device and the service thereof. The control point could search the webpage which represents the device also. Then, the control point is able to utilize those descriptions and webpages, if they exit, to send commands to the device to control it. The device will act to the news, execute the command and send news to the control point to provide information of the status thereof.

Specifically, UPnP AV architecture is based on a UPnP structure which is a structure for video and audio equipments able to play multimedia data of a remote server. UPnP equipment comprises the control point and the device. The video and audio device comprises a media server and a media renderer. The media server is a database containing multimedia, storing all kinds of multimedia data, while the media renderer is a video and audio render for playing the information from the multimedia server. The renderer could be a monitor or a speaker. The control point could be a remoter for controlling the device. The device registers to the control point first, and then the control point utilizes a simple object access protocol (SOAP) to control the device to execute commands of play, pause, resume, stop and so on.

However, the way of transmission of the digital media player (DMP) of the aforementioned UPnP AV architecture is one-on-one transmission. It is few to transmit data by one-to-many manner. As illustrated in FIG. 1, a server 10 transmits data to several renderer 22 utilizing a HTTP streaming is shown. Accordingly, the amount of packets transmitted by the server 10 should depend on the number of renderers 22 for the purpose of those renderers 22 playing synchronously. Consequently, those packets with the same content are transmitted on the network, and thus, the network resource is wasted.

As shown in FIG. 2, there is one technology using multicast and real time protocol/real time streaming protocol (RTP/RTSP) which can be utilized to transmit multimedia data from the sever 10 to multi-renderers 22 of a group 20 synchronously to improve the usage efficiency of network resource. However, RTSP only has the function of unilateral control, that is, only the RTSP client could send a request to the RTSP server but it lacks the mechanism of sending a request to the RTSP client by the RTSP server.

Please refer to FIG. 3, it illustrates one of the client 22′ of the group 20 send a request to the server 10, such as a pause command, and the other clients 22, which do not send any request, of the same group 20 are unable to receive any response from the server 10. Therefore, after the pause command is released, the server will stop transmitting data, the client 22′, which sends the request, will enter into a pause status. Meanwhile, the other clients 22, which do not send any request, will lead to a termination status themselves and intend to disconnect the network because those client 22 do not know the newly pause status. Even the client 22′, which sends the pause request, sends a resume request afterward, the server 10 resumes to the status of data transmission and begins transmitting. However, the other clients 22′, not sending the pause command, of the group 20 is unable to resume and fail to execute any sequential command. Only the client 22′, sending the pause and resume command, could act normally. Therefore, the aforementioned prior art do not achieve the objects of controlling devices coordinately, making devices to play synchronously at different places, and thus, degrade the utility and convenience of multimedia transmission on the network.

According to the above-mentioned, in the multimedia data transmission system of the network, for the purpose of saving the network resource and synchronous control at different places, it is essential to construct a group interactive multicast system and a method for group multicast, coordinate and synchronous control to further improve the quality, speed and convenience of data transmission of the network.

### SUMMARY OF THE INVENTION

An object of this invention is to provide a method for group interactive multicast on a network, which a plurality of devices and control points are coupled to. The devices include a server, a first renderer and at least one second renderer. The control points include a server control point and a first renderer control point corresponding to the first renderer. The method comprises the following steps: (a) forming a group including said first renderer and said second renderer; (b) sending a setting command correspondingly to said first renderer by said first renderer control point; (c) feedbacking a first event to said sever control point after said first renderer executes said setting command; (d) sending said setting command to said second renderer by said server control point to request said second renderer to execute said setting command; (e) sending a play command correspondingly to said first renderer by said first renderer control point; (f) feedbacking a second event to said sever control point after said first renderer executes said play command; and (g) sending said play command to said second renderer by said server control point to request said second renderer to execute said play command.

Another object of this invention is to provide a computing system, applied in a network, for group interactive multicast. The computing system comprises a plurality of devices and a plurality of control points, coupled to the network. The devices comprise a plurality of renderers and a server. The renderer forms a group, while the server is used to store a multimedia information and to transmit the multimedia information to the renderers of the group. The server further comprises a data recording medium for storing a group list of said group. The control points further comprise a server control point and a plurality of renderer control points, while the server is used to control the server, search the renderers and register to the renderers. Each of the renderer control points is used to control each of said renderers correspondingly, search the server, register to the server and get the group list from the server. When one of the renderer control points correspondingly sends a command to the first renderer, the first renderer feedbacks a UPnP event to the server. The server transfers the command to the second renderer, the first renderer and the second renderer executes the command simultaneously.

Another object of this invention is to provide a computer readable media which stores a computer program to execute a method for group interactive multicast on a network, which a plurality of devices and control points are coupled to. The devices include server, a first renderer and at least one second renderer. The control points include a server control point and a first renderer control point corresponding to the first renderer. The method comprises the following steps: (a) forming a group including said first renderer and said second renderer; (b) sending a setting command correspondingly to said first renderer by said first renderer control point; (c) feedbacking a first event to said sever control point after said first renderer executes said setting command; (d) sending said setting command to said second renderer by said server control point to request said second renderer to execute said setting command; (e) sending a play command correspondingly to said first renderer by said first renderer control point; (f) feedbacking a second event to said sever control point after said first renderer executes said play command; and (g) sending said play command to said second renderer by said server control point to request said second renderer to execute said play command.

### BRIEF DESCRIPTION OF THE DRAWINGS

FIG. 1 is a diagram of prior art of data transmission utilizing a HTTP streaming;

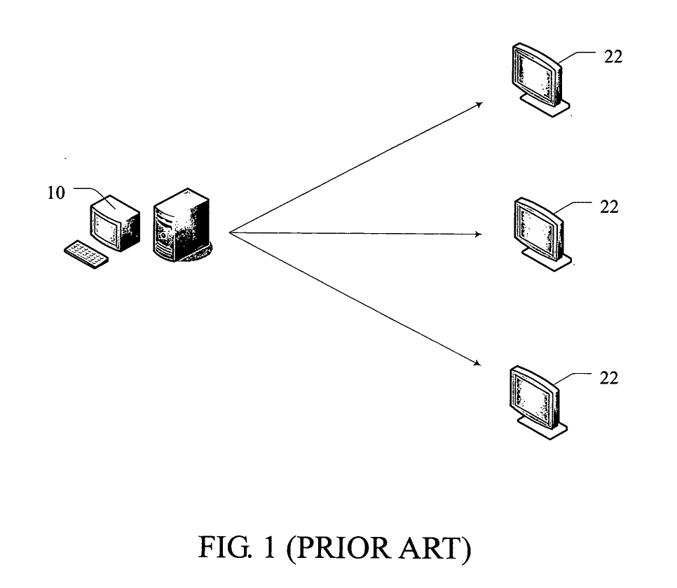

FIG. 2 is a diagram of prior art of data transmission utilizing multicast and RTP/RTSP;

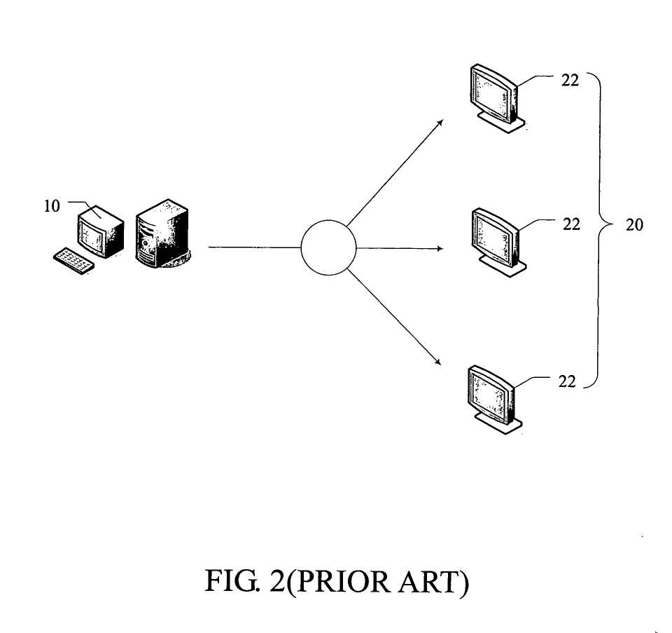

FIG. 3 is a diagram of prior art of data transmission utilizing RTP/RTSP;

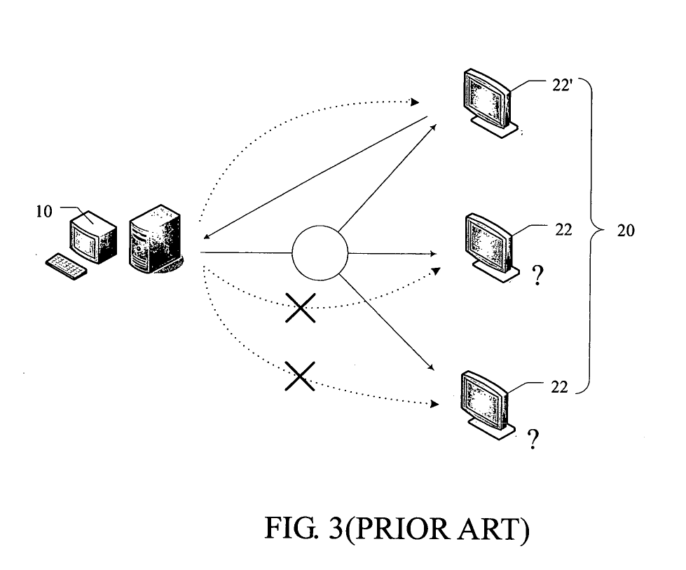

FIG. 4 is a diagram showing a multimedia information transmission system on a network;

FIG. 5 is an operation timing diagram of the computing system of the present invention;

FIG. 6 is a flow chart of the group interactive multicast method of the present invention;

FIG. 7 is an operation timing diagram of the present invention; and

FIG. 8 is an embodiment of the present invention.

### DESCRIPTION OF THE PREFERRED EMBODIMENT

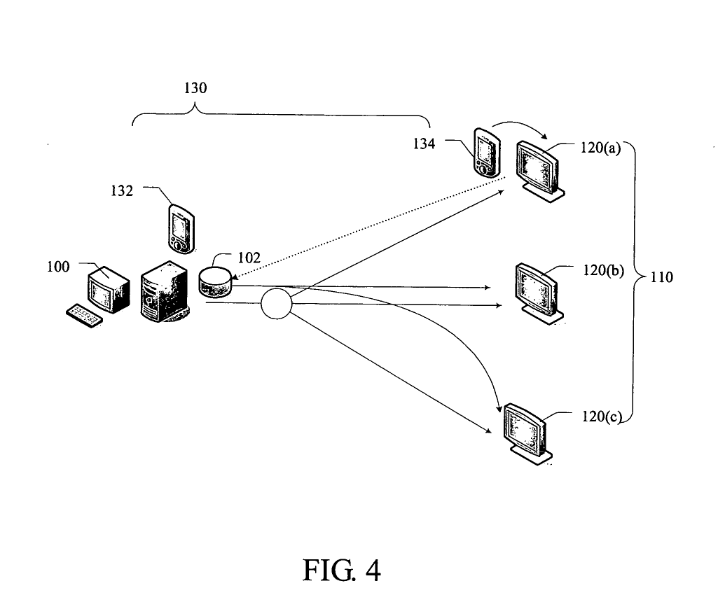

Refer to FIG. 4, it illustrates a multimedia information transmission system on a network. Specifically, the present invention provides a computing system, applied on a network, for group interactive multicast. The computing system comprises a plurality of devices and a plurality of control points. In a preferred embodiment, the computing system utilize a universal plug and play AV architecture (UPnP AV architecture) which AV devices are able to play multimedia AV information of a remote server. The UPnP devices comprise multimedia server 100 and multimedia renderer 120, while the UPnP control points 130 further comprise the server control point 132 and the renderer control point 134.

Particularly, the multimedia server 100 is a multimedia database, which stores all kinds of multimedia information and transmits the multimedia information to multimedia renderer 120. The multimedia renderer 120 comprises a plurality of renderers utilized for receiving and playing those multimedia information from the server 100. Those renderers could be monitors, speakers, etc. Each control point 130 of the computing system is utilized to control UPnP device. More specifically, the server control point 132 and the renderer control point 134 control the multimedia server 100 and the multimedia renderer 120 and monitor the status thereof, respectively. It is noted that, in the preferred embodiment of the present invention, if there are a plurality of renderers coupled to the network, the same amount of the control points are needed for correspondingly control each of the renderers. However, the above mention is just used as the example of the present invention and is not used to limit the range of the present invention. Those skilled in the art could easily modify based on the disclosure of the present invention. For instance, a renderer control point is used to control at least one multimedia renderer.

Continue to refer to FIG. 4, a UPnP architecture is applied in the computing system of the present invention, therefore, the UPnP device has the characteristic of feedbacking an event to each of the control points 130. Moreover, the multimedia server 100 and each of the multimedia renderers 120 of UPnP devices would feedback events to the server control point 132 and the renderer control points, respectively. On the other hand, the control point 130 will respectively register to the server 100 and the renderers 120 of the computing system of the present invention and response to the events came from those UPnP devices. The monitoring mechanism of the aforementioned for the control point to monitor the status of each device is achieved by means of utilizing the register event of the control point to the device and the manner of feedbacking the event to the control point by each device after each device execute the corresponding command when a command is requested by the control point to the device. That is to say, in the UPnP AV architecture, each device, including the multimedia server and the multimedia renderer, will be monitored by a specific control point. When a device is started, the control point will find the device after searching and register an event to the device. When the status of the device change thereafter, the device is able to inform the control point and makes the control point to obtain the newly status thereof. Therefore, this mechanism of the present invention could utilize the characteristic of event feedback by the device to the control point to monitor each multimedia renderers on the network.

Compared with the prior art, the computing system of the present invention form different groups by different multimedia renderers under the UPnP AV architecture for the purpose of group multicast, coordinate and synchronous control among renderers. The server 100 of the computing system of the present invention further comprises a data recording medium 102 for storing a group list of a group. The data recording medium 102 could be a database or a computer readable media, such as a table or any kind of media for storing information.

When one of the groups is desired to act, a group list of the same group will be obtained from the data recording medium 102, and the data will be transmitted according to the group list. In real application, base on the requirement of different data transmission, the server 100 or the renderer control point 134 could choose different renderers 120 on the network to form a plurality of different groups for the purpose of group multicast. For example, renderer 1, renderer 2, renderer 3 and renderer 4 form a group 1. Renderer 5, renderer 6, renderer 7, renderer 8, renderer 9 and renderer 10 form a group 2 (not illustrated), and so forth. Accordingly, a multimedia server could use the group list saved in the data recording medium to transmit different multimedia information among different groups.

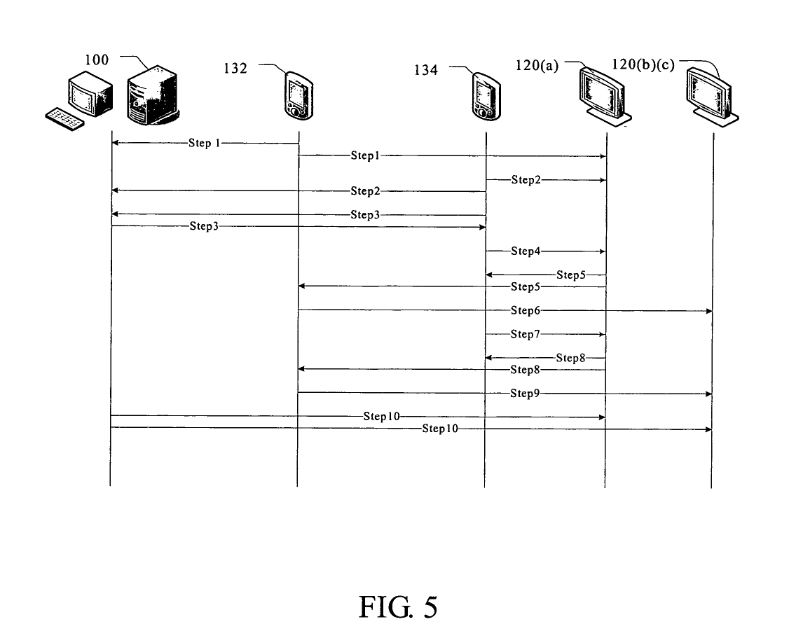

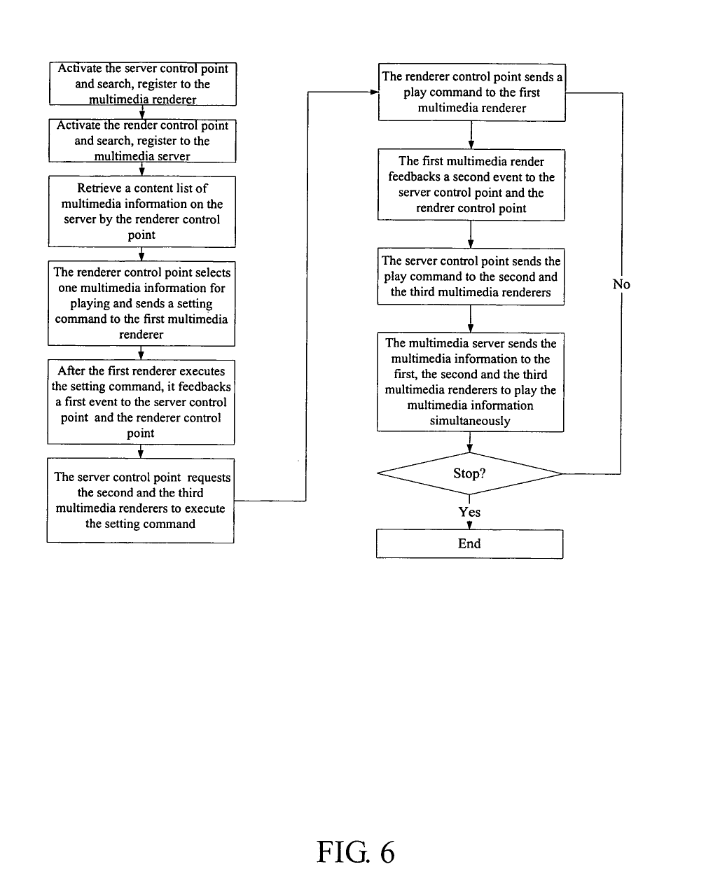

Moreover, the present invention combines the application of multicast technology with the mechanism of event feedback and group setting under the UPnP AV architecture. The multimedia information could be transmitted one-to-one, and moreover, it could be transmitted one-to-many also. The disadvantage of the prior art, the renderer which do not dominate will lose control under unilateral control, will be overcome. That is, the disadvantage of unilateral control of RTSP of the prior art will be solved by the present invention combining the function of event feedback of UPnP AV architecture with RTSP/RTP to achieve the purpose of group multicast. A example of a group 110 consisting of three multimedia renderers 120 will be disclosed in the following. Please refer to FIG. 4, FIG. 5 and FIG. 6 to show the characteristics of the present invention. While FIG. 5 is an operation timing diagram of the server, the server control point, the renderer control point and the renderer of the computing system of the present invention, FIG. 6 is a flow chart of the group interactive multicast method of the present invention.

Step 1. Activate the server control point 132 of the multimedia server 100. Search and register to the first multimedia renderer 120a, the second multimedia renderer 120b and the third multimedia renderer 120c of the group 110 respectively after the server control point 132 has been activated.

Step 2. Activate the renderer control point 134 of the multimedia renderer 120. Search and register to the multimedia server 100. It is noted that the diagram only shows a renderer control point 134 which controls the first multimedia renderer 120a, and thus, the renderer control point 134 acts as the dominating control point in the group 110. The other control points corresponding to the second multimedia renderer 120b and the third multimedia renderer 120c respectively are in the passive status so they are not illustrated. In practical application, each render control point of the group 110 could be the dominating control point. The difference between the status of dominating and passive of the control points is only made by whether they send a control command to the renderer or not. The control point, which sends commands, acts as the dominating control point during the command executing period. On the other hand, those do not send commands are in the passive status. Therefore, the conditions about the second and the third renderer control points acting as the dominating control point are omitted.

Step 3. Retrieve a content list of multimedia information on the server 100 by the renderer control point 134. In the preferred embodiment of the present invention, the content list of multimedia information could be a uniform resource identifier (URI) list.

Step 4. The renderer control point 134 selects one multimedia information for playing and sends a setting command to the first multimedia renderer 120a correspondingly. While in the preferred embodiment, the setting command is a command comprising a multimedia uniform resource identifier.

Step 5. After the first multimedia renderer 120a executes the setting command, it feedbacks a first event to the server control point 132 and the renderer control point 134. While in the preferred embodiment, feedbacking the first event is to feedback an event to report the success about the setting of the multimedia uniform resource identifier.

Step 6. The server control point 132 of the multimedia server 100 sends the setting command to the second multimedia renderer 120b and the third multimedia renderer 120c of the same group 110 respectively after the server control point 132 receives the first event to request the second multimedia renderer 120b and the third multimedia renderer 120c to execute the setting command. While in the preferred embodiment, the setting command is the command which comprises a multimedia uniform resource identifier, described in step 4.

Step 7. The renderer control point 134 sends a play command correspondingly to the first multimedia renderer 120a.

Step 8. The first multimedia render 120a feedbacks a second event to the server control point 132 and the rendrer control point 134 to inform the status of itself after the first multimedia render 120a executes the play command.

Step 9. The server control point 132 of the multimedia server 100 sends the play command to the second multimedia renderer 120b and the third multimedia renderer 120c of the same group 110 respectively after the server control point 132 receives the second event to request the second multimedia renderer 120b and the third multimedia renderer 120c executes the play command.

Step 10. The multimedia server 100 sends the multimedia information to the first multimedia renderer 120a, the second multimedia renderer 120b and the third multimedia renderer 120c of the group 110 respectively so that each multimedia renderer in the group is able to play the multimedia information simultaneously.

Step 11. Judge whether each the multimedia renderer 120 of the group 110 finishes playing the multimedia information or not. If yes, stop playing. If not, repeat the step 7 to the step 11.

It is noted that the command is selected from a group consisting of a play command, a pause command, a resume command and a stop command. For example, if a pause request is needed during the first multimedia renderer 120a playing, the step 7 to the step 9 could be applied to request the second multimedia renderer 120b and the third multimedia renderer 120c of the group 110 execute the pause command, and thus, enter a pause status. After the renderer control point 134, which controls the first multimedia renderer 120a, sends a resume command and the server transfers the resume command to the second multimedia renderer 120b and the third multimedia renderer 120c, they will resume playing simultaneously. The disadvantage of the prior art, described above, about the status of losing connection of the second multimedia renderer 120b and the third multimedia renderer 120c will be overcome by the present invention.

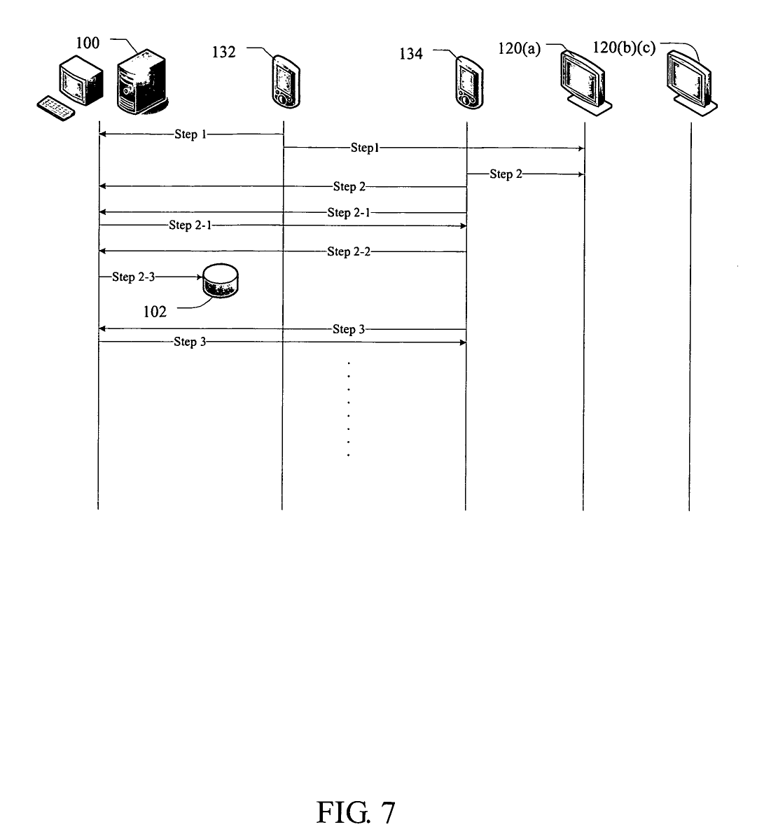

Moreover, the group interactive multicast method disclosed by the present invention further comprises a group list update process as described in the following steps. That is, after the step 2 of the aforementioned, the method further comprises a step to renew the group list, as illustrated in FIG. 7, which shows an operation timing diagram of the present invention, wherein the server comprises a data recording medium. Step 1 and Step 2 are omitted because they are the same with the aforementioned.

Step 2-1. The renderer control point 134 of the multimedia renderer 120a retrieves the group list from the multimedia server 100.

Step 2-2. If it is necessary to update the group list, the renderer control point 134 would renew the list and transmit it back to the data recording medium 102 of the multimedia server 100. Specially, any renderer, coupled to the network, is able to choose to join or quit the original group anytime; therefore, to update the group list is essential for the present invention.

Step 2-3. Select and confirm a group list. Transmit the updated group list back to the data recording medium 102 of the multimedia server 100. Consequently, in the following processes, the renderers of the same group are able to act coordinately and synchronously.

Next, the above-mentioned method may be executed by using a computer program product which stores a computer program. The computer program comprises code to execute the above-mentioned steps of the method. The computer program product can be a floppy disk, a hard disk, an optical disc, a flash disk, a tape, an internet accessible database or any storage medium with a similar functionality of storage which is easily thought by people skilled in the art.

According to the group setting of the aforementioned, the present invention is able to be applied in many applications. For examples, it can be applied in digital families, conferences, meetings, exhibits and schools, etc. Specifically, in a digital family, if there are many multimedia renderers are controlled by a server, one multimedia information is able to controlled at different places in the house synchronously and simultaneously via those renderers. For instances, if a user watch a movie in the living room originally, and then, he is able to use the renderer control point, such as a remoter in the living room, to pause the play of the movie in the living room. After he moves to the kitchen, he is able to use the renderer control point in the kitchen to resume playing the movie so that the user can continuously watch the movie via the renderer in the kitchen. The purpose of interactive control is made in this manner. One more embodiment, the present invention is able to be applied in conferences that participants located at different places could use and share those meeting information synchronously via the connection of the network. More specially, each participant is able to control the contents in the meeting by turns to enhance the effect of interactive communication thereof.

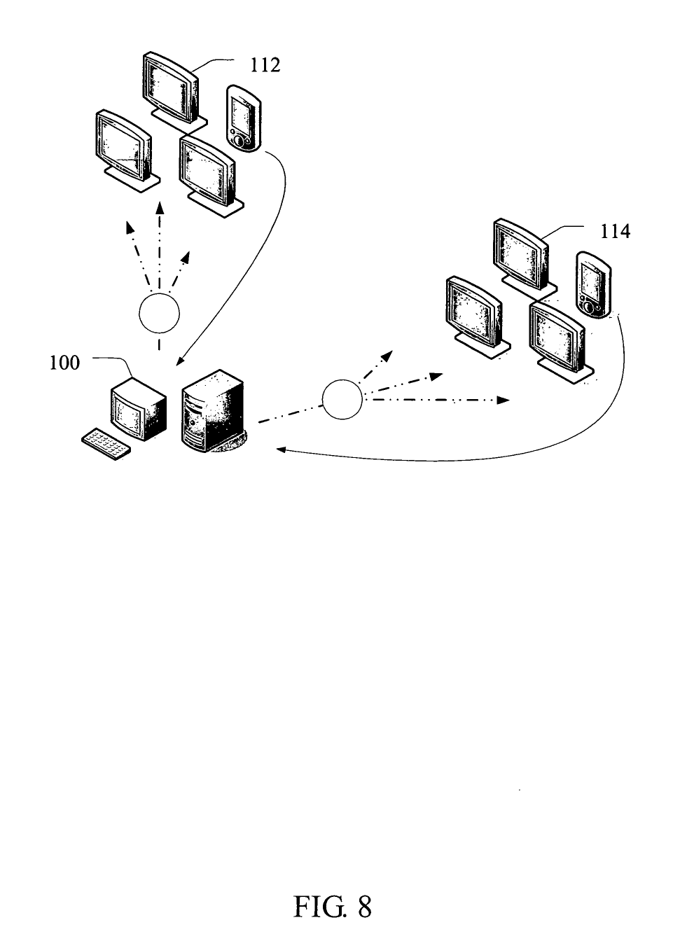

Moreover, the present invention is able to be utilized in electrical teaching instruments in schools. As illustrated in FIG. 8, it shows a server control center 110 and two different groups, while the group 112 represents the group, comprising a plurality of renderers applied in a teaching environment of the junior grade of a school. The renderers of the group 112 disposed in the classrooms of the junior grade can play all kinds of multimedia information for teaching activities. The renderers using the method disclosed by the present invention can easily be controlled interactively for the progress of teaching activities.

As to the renderers of the group 114, they are able to be used in the senior grade of the school. The renderers of the group 114 disposed in the classrooms of the senior grade can play the proper multimedia information for their teaching activities for interactive effects.

To sum up, the present invention combines the features of the stander UPnP AV architecture and that of the multicast streaming technology to provide a solution about group control. The above embodiments are used as the examples of the subject invention and used to explain the technical characters of the subject invention and are not used to limit the range of the subject invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for group interactive multicast, applied on a network, a plurality of devices and control points coupled to said network, said devices including a server, a first renderer and at least one second renderer, said control points including a server control point and a first renderer control point corresponding to said first renderer, said method comprising:
(a) forming a group including said first renderer and said second renderer;
(b) sending a setting command correspondingly to said first renderer by said first renderer control point;
(c) feedbacking a first event to said sever control point after said first renderer executes said setting command;
(d) sending said setting command to said second renderer by said server control point to request said second renderer to execute said setting command;
(e) sending a play command correspondingly to said first renderer by said first renderer control point;
(f) feedbacking a second event to said sever control point after said first renderer executes said play command; and
(g) sending said play command to said second renderer by said server control point to request said second renderer to execute said play command.

2. The method of claim 1, wherein the step (a) comprises:
(a1) searching said devices on said network after said server control point starts and registering to said devices;
(a2) searching said devices on said network after said renderer control point starts and registering to said devices;
(a3) storing a group list on said server to form said group; and
(a4) getting said group list from said server by said first renderer control point.

3. The method of claim 1, wherein the step (b) comprises:
(b1) getting a multimedia information list from said server by said first control point;
(b2) choosing multimedia data from said multimedia information list by said first control point; and
(b3) sending a setting command to said first renderer by said first renderer control point to control said first renderer to execute said setting command.

4. The method of claim 3, wherein said multimedia information list is a uniform resource identifier (URI) list.

5. The method of claim 4, wherein said setting command is a command for setting a multimedia uniform resource identifier.

6. The method of claim 1, wherein the step (c) further comprises the step of feedbacking said first event to said first renderer control point.

7. The method of claim 1, wherein the step (f) further comprises the step of feedbacking said second event to said first renderer control point.

8. The method of claim 3, wherein the step (g) comprises:
(h) transmitting said multimedia information to said first renderer and said second renderer of said group for playing said multimedia information by said first renderer and said second renderer; and
(i) stop transmitting said multimedia information to said first renderer and said second renderer when said first renderer and said second renderer finish playing said multimedia information.

9. The method of claim 8, wherein said play command further comprises a pause command, a resume command and a stop command.

10. The method of claim 1, wherein said server further comprises a data recording medium for storing said group list.

11. The method of claim 10, wherein the step (a) further comprises a step of updating said group list by transmitting a new group list to said data recording medium of said server after said renderer control point re-select said new group list.

12. The method of claim 8, wherein the step (h) further comprises the step of transmitting said multimedia information by real time protocol/real time streaming protocol (RST/RTSP).

13. The method of claim 8, wherein the step (h) further comprises the step of transmitting said multimedia information by multicast.

14. The method of claim 1, wherein said devices are universal plug and play control devices (UPnP Devices).

15. The method of claim 1, wherein said control points are universal plug and play control points (UPnP CP).

16. A computing system for group interactive multicast, coupled to a network, said computing system comprising:
a plurality of devices, coupled to said network, said devices comprising:
a plurality of renderers, forming a group, said renderers comprising a first renderer and at least one second renderer; and
a server for storing a multimedia information and transmitting said multimedia information to said renderers of said group, said server further comprising a data recording medium for storing a group list of said group; and
a plurality of control points, coupled to said network, said control points comprising:
a server control point for controlling said server, searching said renderers and registering to said renderers; and
a plurality of renderer control points, each of said renderer control points controlling each of said renderers correspondingly, searching said server, registering to said server and getting said group list from said server,
when one of said renderer control points correspondingly sends a command to said first renderer, said first renderer feedback a UPnP event to said server, said server transferring said command to said second renderer, said first renderer and said second renderer executing said command simultaneously.

17. The computing system of claim 16, wherein said multimedia information comprises a uniform resource identifier.

18. The computing system of claim 16, wherein said play command further comprises a pause command, a resume command and a stop command.

19. The computing system of claim 16, wherein said server transmits said multimedia information by real time protocol/real time streaming protocol (RST/RTSP).

20. The computing system of claim 16, wherein said server transmits said multimedia information by multicast.

21. The computing system of claim 16, wherein said devices are universal plug and play control devices.

22. The computing system of claim 16, wherein said control points are universal plug and play control points.
